(19) United States
(12) Patent Application Publication
(10) Pub. No.: US 2010/0063243 A1
(43) Pub. Date: Mar. 11, 2010

(54) POLYAMIC ACIDS, POLYIMIDES, AND PROCESSES FOR THE PRODUCTION THEREOF

(75) Inventors: Hideo Suzuki, Chiba (JP); Takayuki Tamura, Chiba (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Nissan Chemical Industries Ltd, Chiyoda-ku Tokyo (JP)

(21) Appl. No.: 11/909,896

(22) PCT Filed: Mar. 24, 2006
(86) PCT No.: PCT/JP2006/305972

§ 371 Date: Sep. 27, 2007

(30) Foreign Application Priority Data
Mar. 29, 2005 (JP) 2005 093393

(51) Int. Cl. C08G 73/10; C08G 69/08

(52) U.S. Cl. 528/322; 528/310

(57) ABSTRACT

To provide polyamic acids and polyimides, which have high light transmittance and heat resistance such that their thermal decomposition temperatures are at least 300° C. and which are excellent in their solubility in solvents and have their processability improved.

A polyamic acid comprising repeating units represented by the following formula (1), characterized in that at least 10 mol % of A has a structure represented by the formula (2), or a polyimide obtainable by cyclodehydration of such a polyamic acid.

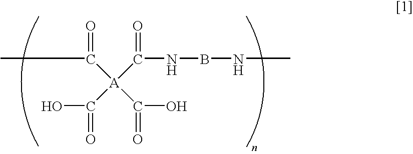

wherein A is a tetravalent organic group, B is a bivalent organic group, and n is a positive integer; and

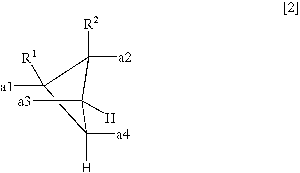

wherein each of R¹ and R² which are independent of each other, is a hydrogen atom, a halogen atom, a C₁₋₁₀ alkyl group, a C₁₋₁₀ halogenated alkyl group, a C₃₋₈ cycloalkyl group, a phenyl group or a cyano group, and a1 to a4 represent binding sites in the formula (1), provided that a1 and a3 are not simultaneously bonded to the carboxyl groups, and a2 and a4 are not simultaneously bonded to the carboxyl groups.

### TECHNICAL FIELD

The present invention relates to polyamic acids and polyimides useful for electronic materials or optical materials, and processes for their production.

### BACKGROUND ART

Usually, polyimide resins are widely used as protecting materials or insulation materials in liquid display devices or semiconductors, or as electronic materials for e.g. color filters, by virtue of their characteristics such as high mechanical strength, heat resistance, insulation properties and solvent resistance. Further, recently, they are expected to be used as optical communication materials such as optical waveguide materials.

However, wholly aromatic polyimide resins are colored deep amber and thus are problematic in an application where high transparency is required. As a method for realizing transparency, it is known that if a polyimide precursor is obtained by a polycondensation reaction of an alicyclic tetracarboxylic dianhydride with an aromatic diamine, and the precursor is imidated to obtain a polyimide, it is possible to obtain a polyimide having high transparency with relatively low coloration (Patent Documents 1 and 2).

In recent years, developments in the electronic material field or in the optical communication material field have been remarkable, and accordingly, higher properties have been required also for the materials to be used. Namely, they are expected not only to be excellent in heat resistance and transparency but also to to have many performances depending upon the particular applications.

Patent Document 1: JP-A-60-006726

Patent Document 2: JP-A-60-188427

### DISCLOSURE OF THE INVENTION

### Object to be Accomplished by the Invention

It is an object of the present invention to provide a polyamic acid and a polyimide thereof for optical material, which have heat resistance such that the thermal decomposition temperature is at least 300° C. and are excellent in solubility in solvents so that their processability is improved and which further have high light transmittance and are expected to be useful as protecting materials in liquid crystal display devices or semiconductors, as electronic materials such as insulation materials, or as optical communication materials for e.g. optical waveguides.

### Means to Accomplish the Object

The present inventors have conducted an extensive research to accomplish the above object, and as a result, have accomplished the present invention.

Namely, the present invention provides the following:

(1) A polyamic acid comprising repeating units represented by the following formula (1), characterized in that at least 10 mol % of A has a structure represented by the formula (2)

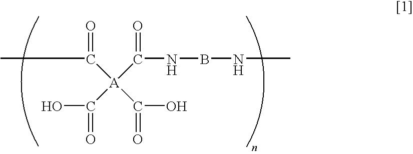

wherein A is a tetravalent organic group, B is a bivalent organic group, and n is a positive integer; and

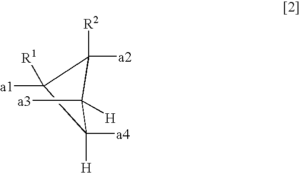

wherein each of R¹ and R² which are independent of each other, is a hydrogen atom, a halogen atom, a C₁₋₁₀ alkyl group, a C₁₋₁₀ halogenated alkyl group, a C₃₋₈ cycloalkyl group, a phenyl group or a cyano group, and a1 to a4 represent binding sites in the formula (1), provided that a1 and a3 are not simultaneously bonded to the carboxyl groups, and a2 and a4 are not simultaneously bonded to the carboxyl groups.

(2) The polyamic acid according to the above (1), wherein in the formula (2), each of R¹ and R² which are independent of each other, is a hydrogen atom or a methyl group.

(3) The polyamic acid according to the above (1), wherein in the formula (1), B is a bivalent organic group derived from an alicyclic diamine or an aliphatic diamine.

(4) A process for producing a polyamic acid as defined in any one of the above (1) to (3), characterized by reacting a tetracarboxylic dianhydride containing at least 10 mol % of a tetracarboxylic dianhydride represented by the formula (3), with a diamine:

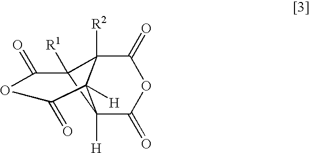

wherein each of R¹ and R² which are independent of each other, is a hydrogen atom, a halogen atom, a C₁₋₁₀ alkyl group, a C₁₋₁₀ halogenated alkyl group, a C₃₋₈ cycloalkyl group, a phenyl group or a cyano group.

(5) A polyimide obtainable by cyclodehydration of a polyamic acid as defined in any one of the above (1) to (3).

(6) A polyimide obtainable by cyclodehydration of a polyamic acid as defined in any one of the above (1) to (3), by means of acetic anhydride and a metal salt of an organic acid.

(7) A process for producing an imide compound, characterized by cyclodehydration of an amic acid compound containing a structure represented by the following formula (4), by means of acetic anhydride and a metal salt of an organic acid:

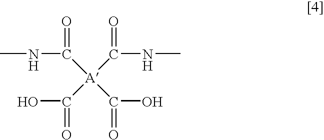

wherein A′ is a tetravalent organic group represented by the following formula (2):

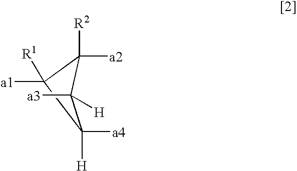

wherein each of R¹ and R² which are independent of each other, is a hydrogen atom, a halogen atom, a C₁₋₁₀ alkyl group, a C₁₋₁₀ halogenated alkyl group, a C₃₋₈ cycloalkyl group, a phenyl group or a cyano group, and a1 to a4 represent binding sites to carbonyl groups, provided that a1 and a3 are not simultaneously bonded to the carboxyl groups, and a2 and a4 are not simultaneously bonded to the carboxyl groups.

(8) The process for producing a polyimide according to the above (7), wherein the amic acid compound is a polyamic acid having repeating units represented by the formula (1)

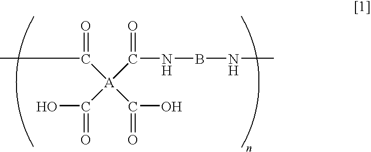

wherein A is a tetravalent organic group, B is a bivalent organic group, and n is a positive integer.

### EFFECTS OF THE INVENTION

The polyamic acid and the polyimide of the present invention have high light transmittance and heat resistance such that the thermal decomposition temperature is at least 300° C. and are excellent in solubility in various solvents so that their processability is improved.

### BRIEF DESCRIPTION OF THE DRAWINGS

FIG. 1 is a wavelength-light transmittance graph of cageCBDA-DPP polyimide film in Example 9.

FIG. 2 is a wavelength-light transmittance graph of cageCBDA-DPP polyimide film in Example 10.

FIG. 3 is a wavelength-light transmittance graph of cageCBDA-DCHM polyimide film in Example 11.

FIG. 4 is a wavelength-light transmittance graph of cageCBDA-DCHM polyimide film in Example 12.

### BEST MODE FOR CARRYING OUT THE INVENTION

Now, the present invention will be described in detail.

The polyamic acid of the present invention is a polyamic acid characterized in that in the repeating units represented by the formula (1), at least 10 mol % of A being a tetravalent organic group, has a structure represented by the formula (2).

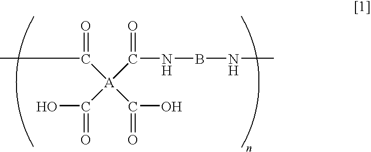

wherein A is a tetravalent organic group, B is a bivalent organic group, and n is a positive integer; and

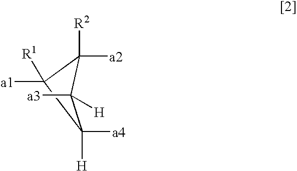

wherein each of R¹ and R² which are independent of each other, is a hydrogen atom, a halogen atom, a C₁₋₁₀ alkyl group, a C₁₋₁₀ halogenated alkyl group, a C₃₋₈ cycloalkyl group, a phenyl group or a cyano group, and a1 to a4 to represent binding sites in the formula (1), provided that a1 and a3 are not simultaneously bonded to the carboxyl groups, and a2 and a4 are not simultaneously bonded to the carboxyl groups.

In the formula (2), a1 to a4 represent binding sites is in the formula (1), respectively. Namely, it is meant that at the respective positions of a1 to a4, the carboxyl group, or the carbonyl group constituting the polymer main chain, in the formula (1) is bonded. However, a1 and a3 are not simultaneously bonded to the carboxyl groups, and a2 and a4 are not simultaneously bonded to the carboxyl groups. Further, the formula (1) has cyclobutane as the basic skeleton, and a1 to a4 are on this ring so that the adjacent ones are in a positional relation of trans-trans-trans.

In the formula (2), each of R¹ and R² which are independent of each other, is a hydrogen atom, a halogen atom, a C₁₋₁₀ alkyl group, a C₁₋₁₀ halogenated alkyl group, a C₃₋₈ cycloalkyl group, a phenyl group or a cyano group, preferably a hydrogen atom or a methyl group.

In the polyamic acid of the present invention, the structure of the formula (2) is at least 10 mol %, preferably at least 50 mol %, more preferably at least 80 mol %, of A in the formula (1). 100 mol % of A may be of the structure of the formula (2).

A polyamic acid wherein 100 mol % of A in the formula (1) is of the structure of the formula (2), can be obtained by a reaction of a tetracarboxylic dianhydride represented by the following formula (3) with a diamine:

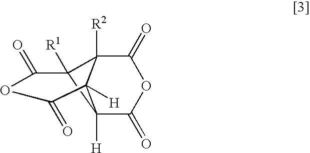

In the formula (3), each of R¹ and R² which are independent of each other, is a hydrogen atom, a halogen atom, a C₁₋₁₀ alkyl group, a C₁₋₁₀ halogenated alkyl group, a C₃₋₈ cycloalkyl group, a phenyl group or a cyano group.

Here, the tetracarboxylic dianhydride represented by the formula (3) can be obtained by a method such as the following Scheme 1 or Scheme 2.

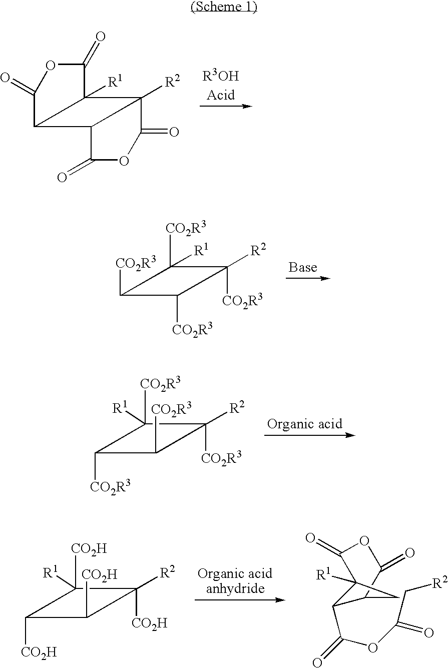

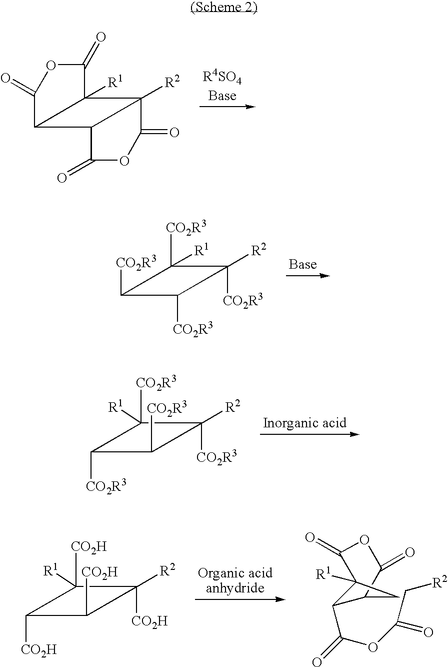

In Scheme 1 or 2, each of R¹ and R² which are independent of each other, is a hydrogen atom, a halogen atom, a C₁₋₁₀ alkyl group, a C₁₋₁₀ halogenated alkyl group, a C₃₋₈ cycloalkyl group, a phenyl group or a cyano group, and each of R³ and R⁴ which are independent of each other, is a C₁₋₃₀ alkyl group.

Among tetracarboxylic dianhydrides represented by the formula (3), particularly preferred specific examples may be 1,2,3,4-cyclobutane tetracarboxylic acid-1,3:2,4-dianhydride, and 1,2-demethyl-1,2,3,4-cyclobutane tetracarboxylic acid-1,3:2,4-dianhydride.

Further, a polyamic acid wherein the structure of the formula (2) is at least 10 mol % and less than 100 mol % of A in the formula (1), can be obtained by a reaction of a tetracarboxylic dianhydride represented by the formula (3), other tetracarboxylic dianhydrides and a diamine. By adjusting the ratio of the tetracarboxylic dianhydride represented by the formula (3) to be at least 10 mol % among the tetracarboxylic dianhydrides to be used for the preparation of a polyamic acid, it is possible to obtain a polyamic acid wherein at least 10 mol % of A in the formula (1) is of the structure of the formula (2). The content of the structure of the formula (2) can be adjusted by the ratio of the tetracarboxylic dianhydride represented by the formula (3) to other tetracarboxylic dianhydrides to be used.

Such other tetracarboxylic dianhydrides to be used to obtain the polyamic acid of the present invention are not particularly limited. Further, such tetracarboxylic dianhydrides may be used alone or in combination as a mixture of two or more of them.

Specific examples of such other tetracarboxylic dianhydrides may be alicyclic tetracarboxylic dianhydrides such as 1,2,3,4-cyclobutane tetracarboxylic acid-1,2:3,4-dianhydride, 2,3,4,5-tetrahydrofuran tetracarboxylic dianhydride, 1,2,4,5-cyclohexane tetracarboxylic dianhydride, 3,4-dicarboxy-1-cyclohexylsuccinic dianhydride, 3,4-dicarboxy-1,2,3,4-tetrahydro-1-naphthalene succinic dianhydride and bicyclo[3.3.0]octane-2,4,6,8-tetracarboxylic dianhydride.

Further, aromatic tetracarboxylic dianhydrides may be mentioned such as pyromellitic dianhydride, 2,3,6,7-naphthalene tetracarboxylic dianhydride, 1,2,5,6-naphthalene tetracarboxylic dianhydride, 1,4,5,8-naphthalene tetracarboxylic dianhydride, 2,3,6,7-anthracene tetracarboxylic dianhydride, 1,2,5,6-anthracene tetracarboxylic dianhydride, 3,3′,4,4′-biphenyltetracarboxylic dianhydride, 2,3,3′,4′-biphenyltetracarboxylic dianhydride, bis(3,4-dicarboxyphenyl)ether dianhydride, 3,3′,4,4′-benphenone tetracarboxylic dianhydride, bis(3,4-diacarboxyphenyl)methane dianhydride, 2,2-bis(3,4-dicarboxyphenyl)propane dianhydride, 1,1,1,3,3,3-hexafluoro-2,2-bis(3,4-dicarboxyphenyl)propane dianhydride, bis(3,4-dicarboxyphenyl)dimethylsilane dianhydride, bis(3,4-dicarboxyphenyl)diphenylsilane dianhydride, 2,3,4,5-pyridine tetracarboxylic dianhydride and 2,6-bis(3,4-dicarboxyphenyl)pyridine dianhydride.

The diamine to be used to obtain the polyamic acid of the present invention is not particularly limited. For example, an aromatic diamine such as p-phenylene diamine, m-phenylene diamine, 2,5-diaminotoluene, 2,6-diaminotoluene, 1,3-bis(4,4′-aminophenoxy)benzene, 4,4′-diamino-1,5-phenoxypentane, 4,4′-diamiobiphenyl, 3,3′-dimethyl-4,4′-diaminobiphenyl, 3,3′-dimethoxy-4,4′-diaminobiphenyl, 4,4′-diaminodiphenyl ether, 4,4′-diaminodiphenyl methane, 2,2′-diaminodiphenyl propane, bis(3,5-diethyl-4-aminophenyl)methane, diaminodiphenyl sulfone, diaminobenzophenone, diaminonaphthalene, 1,4-bis(4-aminophenoxy)benzene, 1,4-bis(4-aminophenyl)benzene, 9,10-bis(4-aminophenyl)anthracene, 1,3-bis(4-aminophenoxy)benzene, 4,4′-bis(4-aminophenoxy)diphenyl sulfone, 2,2-bis[4-(4-aminophenoxy)phenyl]propane or 2,2′ trifluoromethyl-4,4′-diaminobiphenyl; an alicyclic diamine such as 1,4-diaminocyclohexane, 1,4-cyclohexane bis(methylamine), 4,4′-diaminodicyclohexylmethane, bis(4-amino-3-methylcyclohexyl)methane, 3(4),8(9)-bis(aminomethyl)tricyclo[5.2.1.0^{2,6}]decane, 2,5(6)-bis(aminomethyl)bicyclo[2.2.1]heptane, 1,3-diaminoadamantane, 3,3′-diamino-1,1′-biadamantyl or 1,6-diaminodiadamantane (1,6-aminopentanecyclo[7.3.1.1^{4,12},0^{2,7},0^{6,11}]tetradecane); and an aliphatic diamine such as tetramethylene diamine or hexamethylene diamine, may, for example, be mentioned. Further, such diamines may be used alone or in combination as a mixture of two or more of them.

Among these diamines, it is preferred to use an alicyclic diamine or an aliphatic diamine, whereby the transparency of the polyamic acid of the present invention or the polyimide obtainable thereof, will be higher.

The method for reacting a tetracarboxylic dianhydride with a diamine in order to obtain the polyamic acid of the present invention, is not particularly limited. However, it is simple and convenient to adopt a method of mixing the tetracarboxylic dianhydride and the diamine in an organic solvent to react them. Specific examples of the organic solvent to be used for the reaction may, for example, be m-cresol, N-methyl-2-pyrolidone, N,N-dimethylformamide, N,N-dimethylacetamide, N-methylcaptolactam, dimethylsulfoxide, tetramethylurea, pyridine, dimethylsulfone, hexamethylphosphoramide and butyl lactone. These solvents may be used alone or in combination as a mixture. Further, even a solvent which does not dissolve the polyamic acid may be used as added to the above solvent within a range where a uniform solution can be obtained. As the reaction temperature for the solution polymerization, an optional temperature may be selected from −20° C. to 150° C., preferably from −5° C. to 100° C. Further, the molecular weight of the polyamic acid may be controlled by changing the molar ratio of the tetracarboxylic dianhydride to the diamine to be used for the reaction, and in the same manner as a usual polycondensation reaction, the closer this molar ratio to 1, the larger the molecular weight of the resulting polyamic acid.

The method of mixing the tetracarboxylic dianhydride and the diamine in an organic solvent may, for example, be a method wherein a solution having the diamine dispersed or dissolved in an organic solvent, is stirred, and the tetracarboxylic dianhydride may be added as it is or as dispersed or dissolved in an organic solvent, a method wherein inversely, the diamine is added to a solution having the tetracarboxylic dianhydride dispersed or dissolved in an organic solvent, or a method wherein the tetracarboxylic dianhydride and the diamine are alternately added. In the present invention, any of such methods may be employed. Further, in a case where the tetracarboxylic dianhydride or the diamine is composed of a plurality of compounds, such a plurality of compounds may be reacted in a preliminarily mixed state, or may be sequentially reacted separately.

The polyimide of the present invention is a polyimide obtainable by cyclodehydration of the above-described polyamic acid of the present invention. Here, the conversion from the polyamic acid to the polyimide (the cyclodehydration ratio) is defined as the imidation ratio. The imidation ratio of the present invention is not limited to 100%. In the polyimide of the present invention, this imidation ratio may selectively have an optional value of from 1 to 100%, as the case requires.

The method for cyclodehydration of the polyamic acid in order to obtain the polyimide of the present invention, is not particularly limited. For the polyamic acid of the present invention, in the same manner as for a usual polyamic acid, it is possible to adopt ring closure by heating or a method for carrying out ring closure chemically by using a known cyclodehydration catalyst.

In the method by heating, an optional temperature of from 100° C. to 300° C., preferably from 120° C. to 250° C., may be selected.

In the method for carrying out ring closure chemically, it is possible to use, for example, an organic base such as pyridine or triethylamine in the presence of e.g. acetic anhydride. As the temperature at that time, an optional temperature from −20° C. to 200° C. may be selected. For this reaction, the polymerization solution for the polyamic acid may be used as it is, or after being diluted. Otherwise, the polyamic acid may be recovered from the polymerization solution of the polyamic acid by the after-mentioned method, and it may then be dissolved in a suitable organic solvent, followed by the reaction. The organic solvent to be used here, may be the above-mentioned solvent for polymerization for the polyamic acid.

Further, in the present invention, it has been found that at the time of chemically cyclodehydrating an amic acid compound containing a structure represented by the following formula (4), which is obtainable by a reaction of a tetracarboxylic dianhydride represented by the above formula (3) with an amine compound, it is possible to easily obtain an imide compound with a high imidation ratio by means of acetic anhydride and a metal salt of an organic acid.

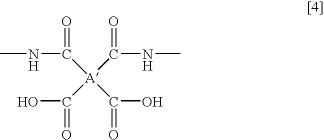

wherein A′ is a tetravalent organic group represented by the following formula (2).

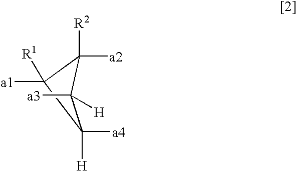

In the formula (2), each of R¹ and R² which are independent of each other, is a hydrogen atom, a halogen atom, a C₁₋₁₀ alkyl group, a C₁₋₁₀ halogenated alkyl group, a C₃₋₈ cycloalkyl group, a phenyl group or a cyano group, and a1 to a4 represent binding sites to carbonyl groups, provided that a1 and a3 are not simultaneously bonded to the carboxyl groups, and a2 and a4 are not simultaneously bonded to the carboxyl groups.

The metal salt of an organic acid to be used for the above reaction may, for example, be an alkali metal salt of an organic acid or an alkaline earth metal salt of an organic acid. Specifically, it may, for example, be lithium formate, sodium formate, magnesium formate, calcium formate, barium formate, lithium acetate, sodium acetate, magnesium acetate, calcium acetate, barium acetate, lithium propionate, sodium propionate, magnesium propionate, calcium propionate or barium propionate. Among them, from the viewpoint of cyclodehydration effect and economical efficiency, an alkali metal salt of acetic acid or an alkaline earth metal salt of acetic acid is preferred, and particularly preferred is sodium acetate. The amount of the metal salt of an organic acid is preferably from 1 to 20 times by mol, particularly preferably from 2 to 10 times by mol, based on one unit of the structure of the above formula (4). The amount of acetic anhydride to be used simultaneously is preferably from 2 to 50 times by mol, particularly preferably from 3 to 30 times by mol, based on one unit of the structure of the formula (4).

The reaction can be carried out in the same manner as in the case of cyclodehydration by means of acetic anhydride and an organic base. As the reaction temperature, an optional temperature may be selected within a range of from 0° C. to 200° C., particularly preferably from 50° C. to 150° C.

As the amic acid compound in this reaction, a polyamic acid having repeating units represented by the above formula (1) may be used, and the polyimide of the present invention may be likewise obtained.

The solution of a polyamic acid or polyimide obtained as described above, may be used as it is. Otherwise, it may be used in the form of a powder isolated by precipitation by means of a poor solvent such as methanol or ethanol, or such a powder may be used as re-dissolved in a suitable solvent. The solvent for such re-dissolution is not particularly limited so long as it is capable of dissolving the obtained polymer powder. Its specific example may, for example, be m-cresol, 2-pyrolidone, N-methylpyrolidone, N-ethylpyrolidone, N-vinylpyrolidone, N,N-dimethylacetamide, N,N-dimethylformamide, hexamethylphosphoramide or γ-butyrolactone.

Further, when the polyamic acid or the polyimide of the present invention is used in the form of a polymer solution, a solvent which does not dissolve the polymer by itself, may be used as added to the above solvent, within a range not to impair the solubility. As a specific example, ethyl cellosolve, butyl cellosolve, ethyl carbitol, butyl carbitol, ethyl carbitol acetate, ethylene glycol, 1-methoxy-2-propanol, 1-ethoxy-2-propanol, 1-butoxy-2-propanol, 1-phenoxy-2-propanol, propylene glycol monoacetate, propylene glycol diacetate, propylene glycol-1-monomethylether-2-acetate, propylene glycol-1-monoethylether-2-acetate, dipropylene glycol, 2-(2-ethoxypropoxy)propanol, methyl lactate, ethyl lactate, n-propyl lactate, n-butyl lactate or isoamyl lactate may, for example, be mentioned. For the purpose of improving the adhesion between the polymer and the substrate, it is of course preferred to add an additive such as a coupling agent.

The molecular weight of the polyamic acid or the polyimide of the present invention is not particularly limited, and a proper molecular weight may be selected depending upon the particular application. However, if the molecular weight is too small, the strength of the material thereby obtainable tends to be inadequate. On the other hand, if the molecular weight is too large, the operation efficiency when made into a polymer solution, tends to be poor. Accordingly, the molecular weight of the polyamic acid or the polyimide of the present invention is preferably from 2,000 to 500,000, more preferably from 5,000 to 300,000, by a number average molecular weight.

Now, the present invention will be described in further detail with reference to Examples. However, it should be understood that the present invention is by no means restricted to such Examples.

### EXAMPLES

In the following Examples, for the measurement of the molecular weight for a polyamic acid or a polyimide, a normal temperature gel permeation chromatography (GPC) apparatus (SSC-7200) manufactured by Kabushikikaisha Senshu Kagaku and a column (KD803, 805) manufactured by Shodex were used, and the measurement was carried out by using DMF as an eluent. The number average molecular weight and the weight average molecular weight were obtained by calibration curves obtained by using polyethylene glycol and polyethylene oxide as standard products.

Further, the imidation ratio of a polyimide was confirmed by the following two methods. (1) A method wherein the polyimide is dissolved in d₆-DMSO (dimethylsulfoxide-d₆), and the ¹H-MNR was measured, whereupon the ratio of amic acid groups remaining without being imidated is obtained from the ratio of the integrated value of proton peaks. (2) A method wherein a polyimide film is formed on a glass plate, and its IR spectrum is measured, and the imidation ratio is obtained from the ratio of the area of absorption of the formed imide (1,774 to 1,698 cm⁻¹) to the area of absorption of the remaining amide (1,630 to 1,650 cm⁻¹).

For the IR measurement, FT-IR (NICOLET 5700) manufactured by Thermo Electron Corporation was used.

For the measurement of the thermal characteristics, a differential thermal gravimetric/calorimetry (TG/DTA) apparatus (Thermoplus TG8120) manufactured by Rigaku Corporation, was used.

The thickness of the polyimide film formed on a glass plate was measured by means of a fully automatic microprofile meter (Surf corder ET 4000A), manufactured by Kosaka Laboratory Ltd.

The ultraviolet-visible absorption spectrum was measured by means of a self-recording spectrophotometer (UV-VIS-NIR Scanning Spectrophotometer) manufactured by Shimadzu Corporation.

### Meanings of Abbreviations in Examples

cageCBDA: 1,2,3,4-cyclobutanetetracarboxylic acid-1,3:2,4-dianhydride

DDE: 4,4′-diaminodiphenyl ether

DDM: 4,4′-diaminodiphenyl methane

p-PDA: p-phenylene diamine

DPP: 4,4′-diamino-1,5-phenoxypentane

DAPB: 1,3-bis(4,4′-aminophenoxy)benzene

DCHM: 4,4′-diaminodicyclohexyl methane

HMPA: hexamethylphosphoramide

NMP: N-methyl-2-pyrolidone

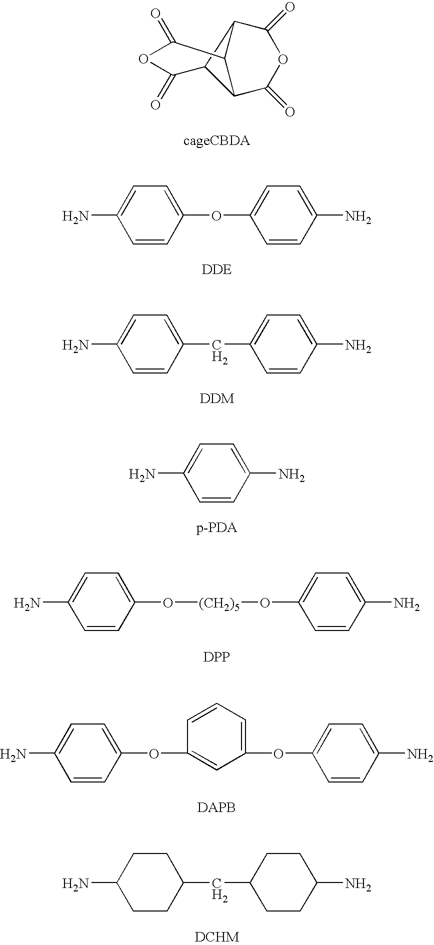

### Example 1

### Preparation of cageCBDA-DDE Polyamic Acid and cageCBDA-DDE Polyimide

Into a dried four necked reaction flask, 0.601 g (3.00 mmol) of DDE and 6.67 g of HMPA were charged and stirred at room temperature of 18° C. by means of a mechanical stirrer to dissolve DDE in HMPA.

Then, 0.576 g (2.94 mmol) of cageCBDA was added and stirred for 43 hours at a rate of 160 rpm at a temperature of 18° C. by means of a mechanical stirrer to obtain a polyamic acid solution of cageCBDA-DDE.

To this polyamic acid solution, 15.7 g of HMPA was added, stirred and diluted, whereupon a small amount was sampled, and the molecular weight was measured. As a result of the GPC measurement, the number average molecular weight (Mn) of the obtained polyamic acid was 6,366, and the weight average molecular weight (Mw) was 13,989, and Mw/Mn was 2.20.

To the above polyamic acid solution after dilution, 0.735 g (7.2 mmol) of acetic anhydride was added, followed by stirring at 18° C. for 5 minutes. Then, 1.09 g (13.8 mmol) of pyridine was added, followed by stirring for 30 minutes. Thereafter, the reaction flask was heated to 120° C. in an oil bath, and stirring was further continued for two hours to obtain a red-colored polyimide solution. This polyimide solution was cooled to room temperature and then dropwise added to 83 ml of methanol with stirring. The milky white mixed solution was continuously stirred for 4 hours, whereby a powder precipitated. This powder was collected by filtration, washed with 118 ml of methanol and then dried under reduced pressure to obtain 0.62 g of a slightly brown powder of cageCBDA-DDE polyimide.

As a result of the GPC measurement, the number average molecular weight (Mn) of the obtained polyimide was 12,526, the weight average molecular weight (Mw) was 26,902, and Mw/Mn was 2.15.

A part of the obtained polyimide powder was dissolved in d₆-DMSO, and the ¹H-NMR was measured, whereby the imidation ratio of this polyimide was 17.9%.

Further, the results of the measurement of the thermal characteristics were as follows.

5% weight reduction temperature (T5): 271.5° C.

10% weight reduction temperature (T10): 319.4° C.

Decomposition temperature (Td): 392.1° C.

### Example 2

### Preparation of cageCBDA-DDM Polyamic Acid and cageCBDA-DDM Polyimide

Using 0.595 g (3.00 mmol) of DDM, 6.70 g of HMPA and 0.588 g (3.00 mmol) of cageCBDA, stirring was carried out for 43 hours in the same manner as in Example 1 to obtain a polyamic acid solution of cageCBDA-DDM.

To this polyamic acid solution, 15.7 g of HMPA was added, stirred and diluted, and then, a small amount was sampled, and the molecular weight measurement was carried out. As a result of the GPC measurement, the number average molecular weight (Mn) of the obtained polyamic acid was 11,618, the weight average molecular weight (Mw) was 30,499 and Mw/Mn was 2.62.

Further, to the polyamic acid solution after dilution, in the same manner as in Example 1, 0.735 g (7.2 mmol) of acetic anhydride and 1.09 g (13.8 mmol) of pyridine were sequentially added, and after heating to 120° C., stirring was carried out for 3 hours to obtain a polyimide solution. From this polyimide solution, in the same manner as in Example 1, 1.04 g of a slightly brown powder of cageCBDA-DDM polyimide was obtained (methanol for precipitation: 83 ml, methanol for washing: 118 ml). The analytical results of the obtained polyimide are shown below.

Number average molecular weight (Mn): 11,152, weight average molecular weight (Mw): 23,931 (Mw/Mn: 2.15)

Imidation ratio: 21.9%

5% weight reduction temperature (T5): 289.7° C.

10% weight reduction temperature (T10): 345.3° C.

Decomposition temperature (Td): 402.6° C.

### Example 3

### Preparation of cageCBDA-p-PDA Polyamic Acid and cageCBDA-p-PDA Polyimide

Using 0.541 g (5.00 mmol) of p-PDA, 13.7 g of HMPA and 0.981 g (5.00 mmol) of cageCBDA, stirring was carried out for 45 hours in the same manner as in Example 1 to obtain a polyamic acid solution of cageCBDA-p-PDA.

To this polyamic acid solution, 15.2 g of HMPA was added, stirred and diluted, and then, a small amount was sampled, and the molecular weight measurement was carried out. As a result of the GPC measurement, the number average molecular weight (Mn) of the obtained polyamic acid was 10,463, the weight average molecular weight (Mw) was 25,219 and Mw/Mn was 2.41.

Further, to the polyamic acid solution after dilution, in the same manner as in Example 1, 1.51 g (14.4 mmol) of acetic anhydride and 2.18 g (27.6 mmol) of pyridine were sequentially added, and after heating to 120° C., stirring was carried out for 3 hours to obtain a polyimide solution. From this polyimide solution, in the same manner as in Example 1, 1.20 g of a flesh-colored powder of cageCBDA-p-PDA polyimide was obtained (methanol for precipitation: 106 ml, methanol for washing: 152 ml). The analytical results of the obtained polyimide are shown below.

Number average molecular weight (Mn): 9,648, weight average molecular weight (Mw): 17,555 (Mw/Mn: 1.82)

Imidation ratio: 26.6%

5% weight reduction temperature (T5): 238.1° C.

10% weight reduction temperature (T10): 316.5° C.

Decomposition temperature (Td): 408.4° C.

### Example 4

### Preparation of cageCBDA-DPP Polyamic Acid and cageCBDA-DPP Polyimide

Using 0.876 g (3.06 mmol) of DPP, 8.23 g of HMPA and 0.576 g (2.94 mmol) of cageCBDA, stirring was carried out for 43 hours in the same manner as in Example 1 to obtain a polyamic acid solution of cageCBDA-DPP.

To this polyamic acid solution, 19.3 g of HMPA was added, stirred and diluted, and then, a small amount was sampled, and the molecular weight measurement was carried out. As a result of the GPC measurement, the number average molecular weight (Mn) of the obtained polyamic acid was 11,593, the weight average molecular weight (Mw) was 23,798 and Mw/Mn was 2.05.

Further, to the polyamic acid solution after dilution, in the same manner as in Example 1, 0.735 g (7.2 mmol) of acetic anhydride and 1.09 g (13.8 mmol) of pyridine were sequentially added, and after heating to 120° C., stirring was carried out for 3 hours to obtain a polyimide solution.

From this polyimide solution, in the same manner as in Example 1, 0.92 g of a slightly brown powder of cageCBDA-DPP polyimide was obtained (methanol for precipitation: 68 ml, methanol for washing: 200 ml). The analytical results of the obtained polyimide are shown below.

Number average molecular weight (Mn): 12,853, weight average molecular weight (Mw): 28,344 (Mw/Mn: 2.20)

Imidation ratio: 17.0%

5% weight reduction temperature (T5): 254.5° C.

10% weight reduction temperature (T10): 306.7° C.

Decomposition temperature (Td): 392.1° C.

### Example 5

### Preparation of cageCBDA-DAPB Polyamic Acid and cageCBDA-DAPB Polyimide

Using 0.876 g (3.13 mmol) of DAPB, 8.23 g of HMPA and 0.576 g (2.94 mmol) of cageCBDA, stirring was carried out for 46 hours in the same manner as in Example 1 to obtain a polyamic acid solution of cageCBDA-DAPB.

To this polyamic acid solution, 19.3 g of HMPA was added, stirred and diluted, and then, a small amount was sampled, and the molecular weight measurement was carried out. As a result of the GPC measurement, the number average molecular weight (Mn) of the obtained polyamic acid was 14,903, the weight average molecular weight (Mw) was 32,391, and Mw/Mn was 2.17.

Further, to the polyamic acid solution after dilution, in the same manner as in Example 1, 0.735 g (7.2 mmol) of acetic anhydride and 1.09 g (13.8 mmol) of pyridine were sequentially added, and after heating to 120° C., stirring was carried out for 3 hours to obtain a polyimide solution.

From this polyimide solution, in the same manner as in Example 1, 1.17 g of a slightly brown powder of cageCBDA-DAPB polyimide was obtained (methanol for precipitation: 102 ml, methanol for washing: 145 ml). The analytical results of the obtained polyimide are shown below.

Number average molecular weight (Mn): 12,002, weight average molecular weight (Mw): 23,666 (Mw/Mn: 1.97)

Imidation ratio: 23.6%

5% weight reduction temperature (T5): 259.9° C.

10% weight reduction temperature (T10): 317.7° C.

Decomposition temperature (Td): 356.5° C.

### Evaluation of the Solubility of Polyimides

The results of the evaluation of the solubility of the polyimides obtained in Examples 1 to 5 in various solvents, are shown in the following Table.

TABLE 1

| | | Solubility of polyimides | | | | |
|---|---|---|---|---|---|---|
| | Polyimide | Ex. 1 | Ex. 2 | Ex. 3 | Ex. 4 | Ex. 5 |
| Solvent | Diamine | DDE | DDM | p-PDA | DPP | DAPB |
| N,N- | | ++ | ++ | ++ | ++ | ++ |
| dimethylformamide | | | | | | |
| (DMF) | | | | | | |
| N,N- | | ++ | ++ | ++ | ++ | ++ |
| dimethylacetamide | | | | | | |
| (DMAc) | | | | | | |
| m-cresol | | ++ | ++ | ++ | ++ | ++ |
| Tetrahydrofuran | | − | − | − | − | − |
| (THF) | | | | | | |
| 1,4-dioxane | | − | − | + | − | − |
| Chloroform | | − | − | − | − | + |
| Pyridine | | ++ | ++ | ++ | ++ | ++ |
| Acetone | | − | − | − | − | − |
| Methanol | | − | − | − | − | − |
| Toluene | | + | − | + | + | ++ |

++: Dissolved at 25° C.,
+: Partially dissolved at 25° C.,
−: Insoluble even under heating

As is evident from the above, the polyimides of the present invention showed solubility in various organic solvents.

### Example 6

### Preparation of cageCBDA-DDE Polyamic Acid and cageCBDA-DDE Polyimide

Into a dried four-necked reaction flask, 1.001 g (5.00 mmol) of DDE and 11.2 g of NMP were charged and stirred at room temperature of 18° C. by means of a mechanical stirrer to dissolve DDE in NMP. Then, 0.981 g (5.00 mmol) of cageCBDA was added, followed by stirring for 24 hours at a rate of 160 rpm at a temperature of 18° C. to obtain a polyamic acid solution of cageCBDA-DDE.

To this polyamic solution, 26.4 g of NMP was added, stirred and diluted, and then, a small amount was sampled, and the molecular weight measurement was carried out. As a result of the GPC measurement, the number average molecular weight (Mn) of the obtained polyamic acid was 11,400, the weight average molecular weight (Mw) was 26,808, and Mw/Mn was 2.35.

To the 19.7 g of the polyamic acid solution after dilution, 3.32 g (32.5 mmol) of acetic anhydride and 0.83 g (10.0 mmol) of sodium acetate were added, followed by stirring for 4 hours in an oil bath of 130° C. to obtain a polyimide solution.

This polyimide solution was cooled to room temperature and then dropwise added to 84 ml of water with stirring. The grayish brown mixed solution was continuously stirred for one hour, whereby a powder precipitated. This powder was collected by filtration, washed twice with 40 ml of water and 40 ml of methanol and then dried under reduced pressure at 65° C. for two hours to obtain 0.92 g of a brown powder of cageCBDA-DDE polyimide.

A part of the obtained polyimide powder was dissolved in d₆-DMSO, and the ¹H-NMR was measured, whereby the imidation ratio of this polyimide was 90.8%.

Further, the results of the measurement of the thermal characteristics were as follows.

5% weight reduction temperature (T5): 331.7° C.

10% weight reduction temperature (T10): 386.0° C.

### Example 7

### Preparation of cageCBDA-p-PDA Polyamic Acid and cageCBDA-p-PDA Polyimide

Using 0.432 g (4.00 mmol) of p-PDA, 6.88 g of NMP and 0.784 g (4.00 mmol) of cageCBDA, stirring was carried out for 24 hours in the same manner as in Example 6 to obtain a polyamic acid solution of cageCBDA-p-PDA.

To this polyamic acid solution, 16.2 g of NMP was added, stirred and diluted, and then, a small amount was sampled, and the molecular weight measurement was carried out. As a result of the GPC measurement, the number average molecular weight (Mn) of the obtained polyamic acid was 13,489, the weight average molecular weight (Mw) was 37,338, and Mw/Mn was 2.77.

Further, to the polyamic acid solution after dilution, 5.30 g (52.0 mmol) of acetic anhydride and 1.33 g (16.2 mmol) of sodium acetate were added, followed by stirring for 4 hours at 130° C. in the same manner as in Example 6 to obtain a polyimide solution.

This polyimide solution was cooled to room temperature and then dropwise added to 130 ml of water with stirring. The stirring was continued for one hour, whereby a powder precipitated. This powder was collected by filtration, washed twice with 50 ml of water and 50 ml of methanol and then dried under reduced pressure at 65° C. for two hours to obtain 1.13 g of a powder of cageCBDA-DDE polyimide.

A part of the obtained polyimide powder was dissolved in d₆-DMSO, and the ¹H-NMR was measured, whereby the imidation ratio of this polyimide was 86.7%.

### Example 8

### Preparation of cageCBDA-DPP Polyamic Acid and cageCBDA-DPP Polyimide

Using 1.15 g (4.00 mmol) of DPP, 11.0 g of NMP and 0.784 g (4.00 mmol) of cageCBDA, stirring was carried out for 24 hours in the same manner as in Example 6 to obtain a polyamic acid solution of cageCBDA-DPP.

To this polyamic acid solution, 25.8 g of NMP was added, stirred and diluted, and then, a small amount was sampled, and the molecular weight measurement was carried out. As a result of the GPC measurement, the number average molecular weight (Mn) of the obtained polyamic acid was 16,554, the weight average molecular weight (Mw) was 47,728, and Mw/Mn was 2.88.

To the polyamic acid solution after dilution, 5.30 g (52.0 mmol) of acetic anhydride and 1.33 g (16.2 mmol) of sodium acetate were added, and then stirred for 4 hours at 130° C. in the same manner as in Example 6 to obtain a polyimide solution.

This polyimide solution was cooled to room temperature and then dropwise added to 160 ml of water with stirring. The stirring was continued for one hour, whereby a powder precipitated. This powder was collected by filtration, washed twice with 30 ml of water and 40 ml of methanol and then dried under reduced pressure at 65° C. for two hours to obtain 1.98 g of a powder of cageCBDA-DDE polyimide.

A part of the obtained polyimide powder was dissolved in d₆-DMSO, and the ¹H-NMR was measured, whereby the imidation ratio of this polyimide was 87.2%.

### Example 9

### Preparation of cageCBDA-DPP Polyamic Acid and cageCBDA-DPP Polyimide Film

Into a dried four-necked reaction flask, 0.573 g (2.00 mmol) of DPP and 6.42 g of NMP were charged and stirred at room temperature of 18° C. by means of a mechanical stirrer to dissolve DPP in NMP. Then, 0.392 g (2.00 mmol) of cageCBDA was added and stirred for 19 hours at a rate of 160 rpm at a temperature of 18° C. to is obtain a polyamic acid solution of cageCBDA-DPP.

As a result of the GPC measurement, the number average molecular weight (Mn) of the obtained polyamic acid was 16,116, the weight average molecular weight (Mw) was 16,656, and Mw/Mn was 1.03.

The obtained polyamic acid polymerization solution was applied on a glass plate by means of a 25 μm doctor blade and baked on a hot plate of 100° C. for 30 minutes and further at 220° C. for one hour to form a polyimide film. The thickness of this polyimide film was 1.19 μm, and the imidation ratio obtained from the IR spectrum was 94%.

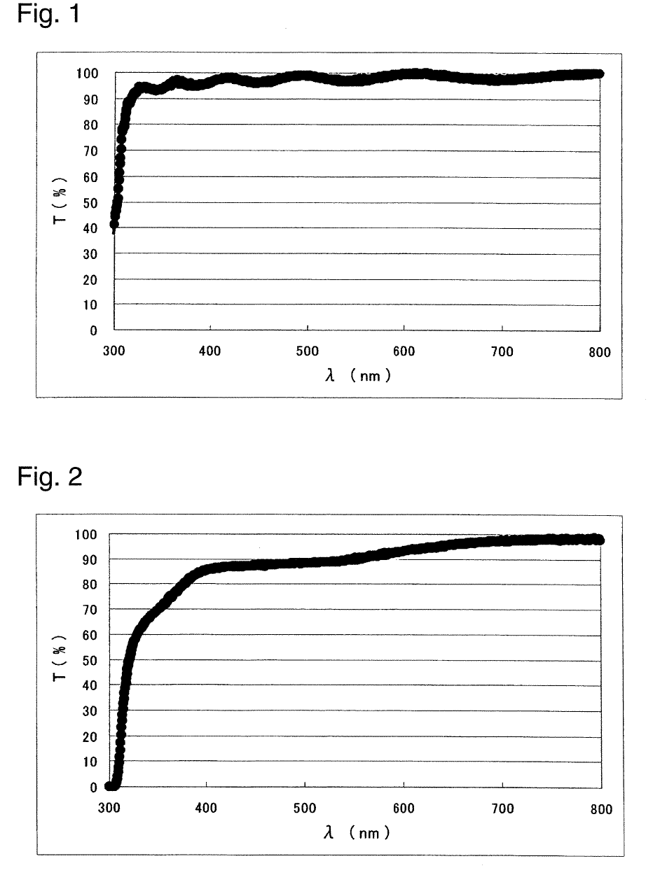

The ultraviolet-visible absorption spectrum of the above polyimide film was measured, whereby the light transmittance in a visible light region (380 to 789 nm) was at least 95%, and even at an i-line wavelength (365 nm), high transmittance of 97% was shown (FIG. 1).

### Example 10

### Preparation of cageCBDA-DPP Polyimide Film

The polyamic acid polymerization solution obtained in Example 9 was applied on a glass plate by means of a 200 μm doctor blade and baked for 30 minutes on a hot plate of 100° C. and further at 160° C. for one hour to form a polyimide film. The thickness of this polyimide film was 11.1 μm, and the imidation ratio obtained from the IR spectrum was 34%.

The ultraviolet-visible absorption spectrum of the above polyimide film was measured, whereby the light transmittance in a visible light region (380 to 780 nm) was at least 80%, and thus high light transmittance was shown (FIG. 2).

### Example 11

### Preparation cageCBDA-DCHM Polyamic Acid and Preparation of cageCBDA-DCHM Polyimide Film

Into a dried four-necked reaction flask, 0.421 g (2.00 mmol) of DCHM and 7.32 g of cresol were charged, and stirred at room temperature of 18° C. by means of a mechanical stirrer to dissolve DCHM in cresol. Then, 0.392 g (2.00 mmol) of cageCBDA was added, followed by stirring for 24 hours at a rate of 160 rpm at a temperature of 18° C. to obtain a polyamic acid solution of cageCBDA-DCHM.

The obtained polyamic acid polymerization solution was applied on a glass plate by means of a 25 μm doctor blade and baked for 30 minutes on a hot plate of 100° C. and further at 220° C. for one hour to form a polyimide film. The thickness of this polyimide was 1.06 μm, and the imidation ratio obtained from the IR spectrum was 98%.

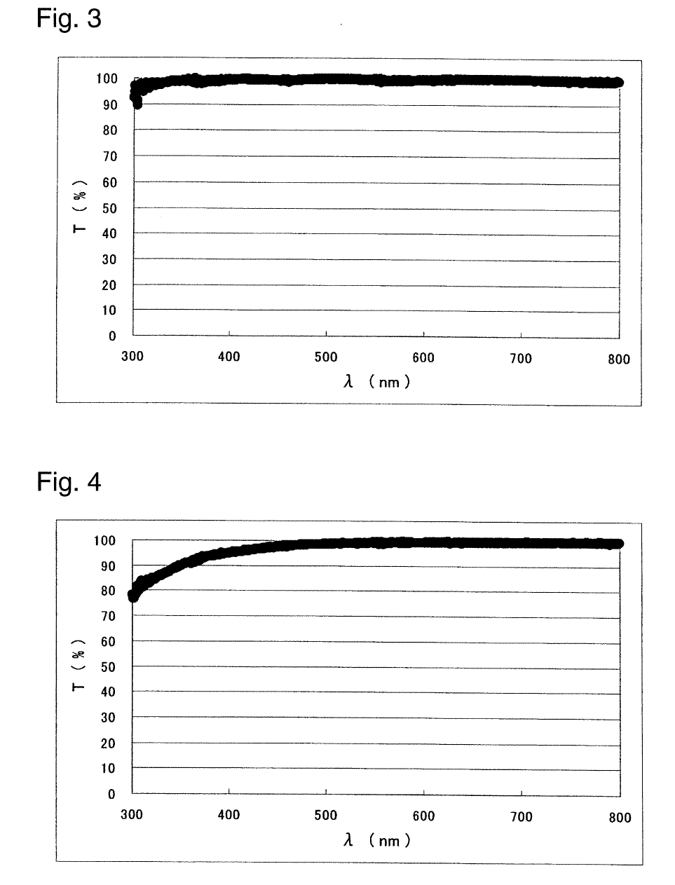

The ultraviolet-visible absorption spectrum of the above polyimide film was measured, whereby the polyimide film having a thickness of 1.06 μm had a light transmittance of at least 98% in a visible light region (380 to 780 nm), and even at an i-line wavelength (365 nm), a high light transmittance of 98% was shown (FIG. 3).

### Example 12

### Preparation of cageCBDA-DCHM Polyimide Film

The polyamic acid polymerization solution obtained in Example 11 was applied on a glass plate by means of a 200 μm doctor blade and baked for 30 minutes on a hot plate of 100° C. and further at 220° C. for one hour to form a polyimide film. The thickness of this polyimide film was 8.81 μm, and the imidation ratio obtained from the IR spectrum was 52%.

The ultraviolet-visible absorption spectrum of the above polyimide film was measured, whereby the light transmittance in a visible light region (380 to 780 nm) was at least 94%, and even at an i-line wavelength (365 nm), a high light transmittance of 91% was shown (FIG. 4).

### INDUSTRIAL APPLICABILITY

The polyamic acids and polyimides of the present invention are expected to be useful as protecting materials in liquid crystal display devices or semiconductors, as electronic materials such as insulation materials, and further as optical communication materials such as optical waveguides.

The entire disclosure of Japanese Patent Application No. 2005-093393 filed on Mar. 29, 2005 including specification, claims, drawings and summary is incorporated herein by reference in its entirety.

1. A polyamic acid comprising repeating units represented by the following formula (1), characterized in that at least 10 mol % of A has a structure represented by the formula (2): 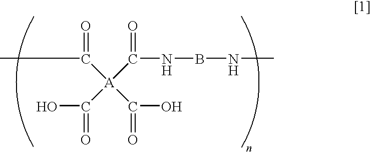
wherein A is a tetravalent organic group, B is a bivalent organic group, and n is a positive integer; and 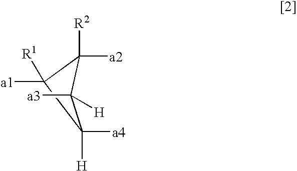
wherein each of R¹ and R² which are independent of each other, is a hydrogen atom, a halogen atom, a C₁₋₁₀ alkyl group, a C₁₋₁₀ halogenated alkyl group, a C₃₋₈ cycloalkyl group, a phenyl group or a cyano group, and a1 to a4 represent binding sites in the formula (1), provided that a1 and a3 are not simultaneously bonded to the carboxyl groups, and a2 and a4 are not simultaneously bonded to the carboxyl groups.

2. The polyamic acid according to claim 1, wherein in the formula (2), each of R¹ and R² which are independent of each other, is a hydrogen atom or a methyl group.

3. The polyamic acid according to claim 1, wherein in the formula (1), B is a bivalent organic group derived from an alicyclic diamine or an aliphatic diamine.

4. A process for producing a polyamic acid as defined in claim 1, characterized by reacting a tetracarboxylic dianhydride containing at least 10 mol % of a tetracarboxylic dianhydride represented by the formula (3), with a diamine: 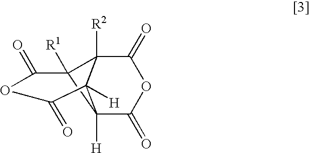
wherein each of R¹ and R² which are independent of each other, is a hydrogen atom, a halogen atom, a C₁₋₁₀ alkyl group, a C₁₋₁₀ halogenated alkyl group, a C₃₋₈ cycloalkyl group, a phenyl group or a cyano group.

5. A polyimide obtainable by cyclodehydration of a polyamic acid as defined in claim 1.

6. A polyimide obtainable by cyclodehydration of a polyamic acid as defined in claim 1, by means of acetic anhydride and a metal salt of an organic acid.

7. A process for producing an imide compound, characterized by cyclodehydration of an amic acid compound containing a structure represented by the following formula (4), by means of acetic anhydride and a metal salt of an organic acid: 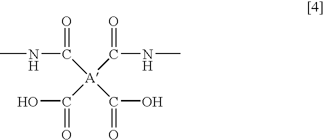
wherein A′ is a tetravalent organic group represented by the following formula (2): 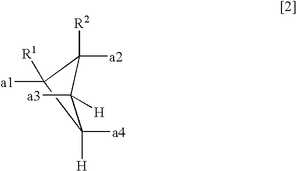
wherein each of R¹ and R² which are independent of each other, is a hydrogen atom, a halogen atom, a C₁₋₁₀ alkyl group, a C₁₋₁₀ halogenated alkyl group, a C₃₋₈ cycloalkyl group, a phenyl group or a cyano group, and a1 to a4 represent binding sites to carbonyl groups, provided that a1 and a3 are not simultaneously bonded to the carboxyl groups, and a2 and a4 are not simultaneously bonded to the carboxyl groups.

8. The process for producing a polyimide according to claim 7, wherein the amic acid compound is a polyamic acid having repeating units represented by the formula (1): 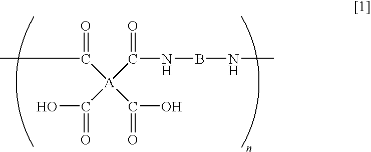
wherein A is a tetravalent organic group, B is a bivalent organic group, and n is a positive integer.
